(19) United States
(12) Patent Application Publication
(10) Pub. No.: US 2018/0169840 A1
(43) Pub. Date: Jun. 21, 2018

(54) NESTED SOCKET ASSEMBLY

(71) Applicant: Oren C. Lowder, Springfield, IL (US)

(72) Inventor: Oren C. Lowder, Springfield, IL (US)

(21) Appl. No.: 15/385,840

(22) Filed: Dec. 20, 2016

(51) Int. Cl. B25B 13/10; B25B 23/00; B25B 21/02

(52) U.S. Cl. CPC B25B 13/102; B25B 21/02; B25B 23/0035

(57) ABSTRACT

A nested socket assembly is disclosed. The nested socket assembly includes an inner socket having a base portion with a double hex pattern which protrudes beyond the adjacent shaft surface of the inner socket. The base portion is adapted to engage an internal double hex pattern of the outer socket. A compression spring presses the inner socket outward of the outer socket. The inner socket is locked within the outer socket via a retaining clip, such as a circlip. The inner socket is free to move inward with respect to the outer socket so that the inner socket may engage a smaller size hex head or nut, but may also be pushed inward so that the outer socket can engage larger hex head or nut. The assembly is configured to attach to an impact driver.

### BACKGROUND OF THE INVENTION

### Field of the Invention

The present invention relates to a nested socket assembly, and more particularly, to a nested socket assembly adapted for use with an impact driver.

### Background

Sockets are well known and commonly used to drive bolts and nuts of various shapes and sizes. Such sockets are commonly attached to wrenches, screw drivers, or power driven impact drivers.

When utilizing tools in situations where various different sizes of nuts and bolts must be used, tool users must generally do one of two things: they must either change the socket on the tool for each new size, or use multiple tools prepared with sockets of different sizes. This can be very inconvenient when repeated tool usage is required.

One industry in particular which requires different sized sockets to be used with frequency is line work, in which workers wear thick insulated gloves when working near energized wires. This makes it even more inconvenient for a worker to have to change the socket in the tool they are using. Thus, it would be highly beneficial if a single socket assembly would provide a user with the ability to engage different sized bolts or nuts without the need to change sockets or use multiple tools.

Various assemblies have been proposed to nest sockets. For example, U.S. Pat. No. 7,387,051 issued to Chiang discloses a tool device having nested sockets. However, the manner of engaging the inner socket and retaining it are not robust and not suitable for use with an impact driver.

Similarly, U.S. Pat. No. 6,098,502 issued to Pendergrass discloses a nested expansible socket. The sockets are retained via a pin method that would not withstand the forces applied with an impact driver.

A number of similar devices have been proposed, however, they do not show an outer socket engaging an inner socket in a stable and robust configuration to allow an impact driver to be used, nor is the method of retaining the inner socket sufficient to withstand such forces.

While various other devices have been proposed, there remains a need for a nested socket assembly which is robust and suitable for use with an impact driver, among other advantages.

### SUMMARY

The present invention is a nested socket assembly. The nested socket assembly allows two different sized hex heads or nuts to be engaged easily without the need to switch or reconfigure tools. The assembly is configured to attach to a power driven impact driver, and is a robust construction which withstands typical forces applied with such an impact driver.

The socket assembly of the present invention, in various configurations, includes an inner socket having a base portion. The base portion has an external pattern which protrudes beyond the surface of the shaft of the inner socket adjacent the base portion.

An outer socket has an internal surface pattern which is configured to engage the external pattern of the base portion of the inner socket. Ideally, the external surface pattern of the base portion is a double hex pattern, and the internal surface of the outer socket is a double hex pattern configured to engage the base portion of the inner socket. Ideally, the base portion of the inner socket has sufficient length to enable the assembly to withstand typical impact driver forces with stability. For example, the base portion ideally has a length in the longitudinal direction at least 0.25 inches. Thus, the outer socket engages the inner socket in a robust manner and is able to drive the inner socket.

The inner socket is prevented from sliding out of the outer socket via a retaining clip, such as a circlip or other suitable retaining clip configuration. In certain embodiments, the retaining clip fits within an indentation, or indented groove, in the inner surface of the outer socket, and protrudes inward to prevent the base portion of the inner socket from moving longitudinally beyond a certain point.

The proximal end of the inner socket is separated from the bottom of the outer socket via a compression spring. Thus, the compression spring presses the inner socket outward so that it is at least even with the distal end of the outer socket, or optionally, protrudes beyond the distal end of the outer socket. However, the inner socket is free to move longitudinally with respect to the outer socket when force is applied to the inner socket from the distal end. The inner socket is able to be moved inward, compressing the compression spring, to the extent that its end is inward from the distal end of the outer socket sufficiently to enable the outer socket to engage a nut or bolt.

In certain embodiments, the inner surface patterns of the inner and outer sockets are double hex patterns adapted to engage hex heads or hex nuts. The inner socket is sized and configured to engage a smaller sized hex head or nut, and the outer socket is sized and configured to engage a larger sized hex head or nut. Thus, the tool user is able to have a tool which is configured to engage two common sized hex heads or nuts. This can be particularly beneficial for a worker who uses gloves, such as thick insulated gloves used in line work where energized wires are present.

Still other objects and advantages of the present invention will become readily apparent to those skilled in the art from the following detailed description, wherein it is shown and described only the preferred embodiments of the invention, simply by way of illustration of the best mode contemplated of carrying out the invention. As will be realized, the invention is capable of other and different embodiments and its several details are capable of modifications in various obvious respects, without departing from the invention. Accordingly, the drawings, wherein like reference numerals represent like features, and description are to be regarded as illustrative in nature and not as restrictive.

### BRIEF DESCRIPTION OF THE DRAWINGS

FIG. 1 illustrates a perspective view of a nested socket assembly disassembled from an impact driver in accordance with one embodiment of the present invention.

FIG. 2 illustrates a perspective view of a nested socket assembly assembled with an impact driver in accordance with one embodiment of the present invention.

FIG. 3 illustrates a perspective view of a disassembled nested socket assembly in accordance with one embodiment of the present invention.

FIG. 4 illustrates a perspective view of a disassembled nested socket assembly in accordance with one embodiment of the present invention.

FIG. 5 illustrates a cut-away view of a nested socket assembly in accordance with one embodiment of the present invention, showing the spring in compressed position.

FIG. 6A illustrates a perspective view of a nested socket assembly in accordance with one embodiment of the present invention in which the inner socket engages a smaller bolt head.

FIG. 6B illustrates a perspective view of a nested socket assembly in accordance with one embodiment of the present invention in which the inner socket is depressed into the outer socket allowing the outer socket to engage a larger bolt head.

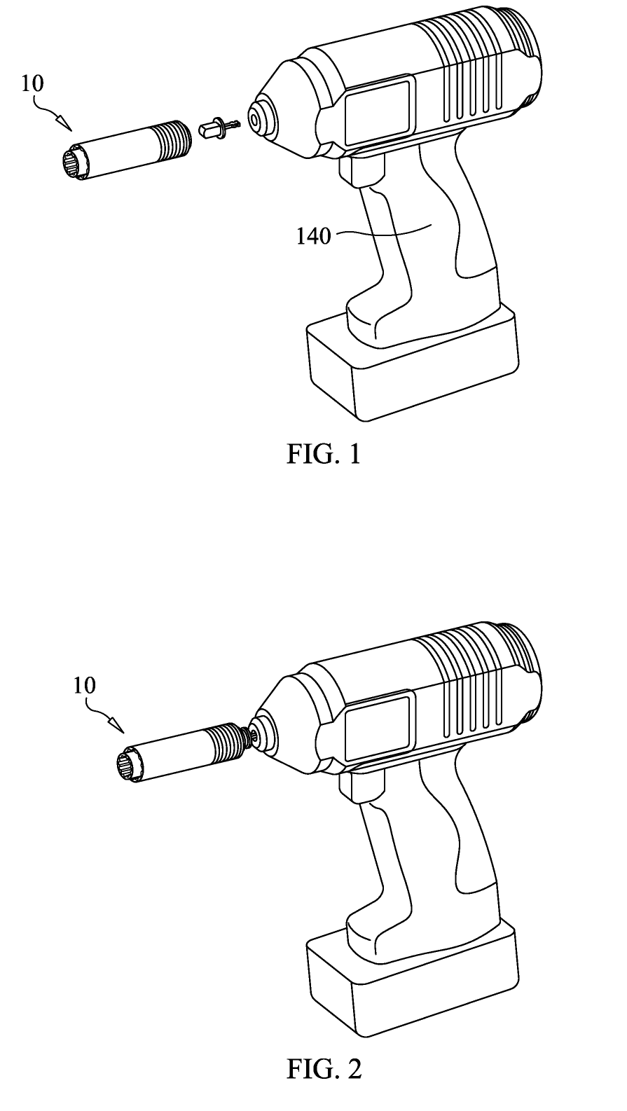

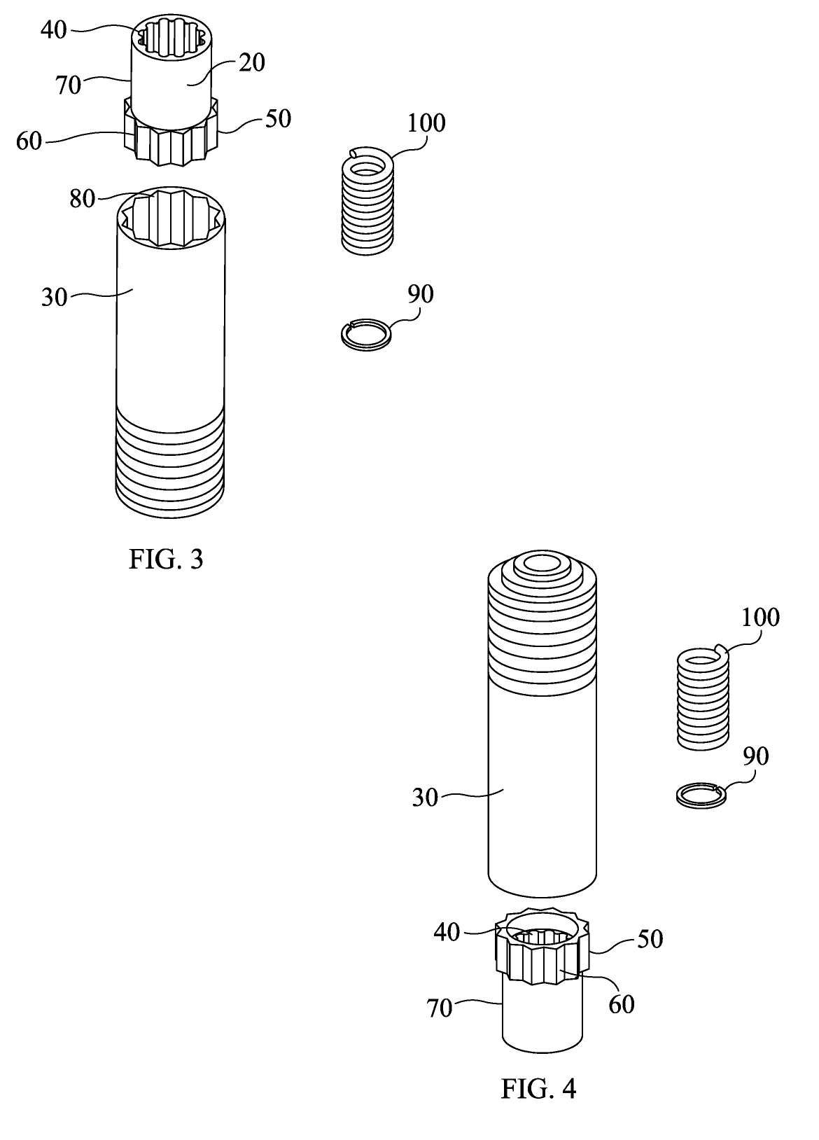

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

In various embodiments, the present invention is a nested socket assembly 10. The assembly 10 includes an inner socket 20 and an outer socket 30. The inner socket 20 has a first internal surface pattern 40 adapted to engage a first nut, and an external surface pattern 50 along a base portion 60 of the inner socket 20, wherein at least a portion of the external surface pattern 50 along the base portion 60 protrudes axially beyond a shaft surface 70 adjacent the base portion 60.

The outer socket 30 has a second internal surface pattern 80 adapted to engage a second hex head or nut larger than the first nut. The surface pattern 80 of the outer socket 30 is also adapted to engage the external surface pattern 50 of the base portion 60 of inner socket 20.

The inner socket 20 is nested within the outer socket 30. However, the inner socket 30 is longitudinally movable with respect to the outer socket 30, and the inner socket 20 is prevented from moving longitudinally beyond a stopping point via a retaining clip 90.

In certain embodiments, the nested socket assembly 10 further includes a compression spring 100 disposed within the outer socket 30 beyond a base of the inner socket 20 and adapted to apply force to push the inner socket 20 toward a distal end of the outer socket 30.

Ideally, the inner socket 20, the outer socket 30, the retaining clip 90, and the spring 100 are positioned in a configuration wherein, under the condition that no pressure is applied to a distal end of the inner socket 20, the distal end of the inner socket 20 is positioned even with or beyond a distal end of the outer socket 30. However, under the condition that force is applied to the distal end of the inner socket 20, the inner socket is free to move longitudinally to the extent that the distal end of the inner socket 20 is positioned inward of the distal end of the outer socket 30. In this manner, a smaller hex head or nut 110 can be engaged using the inner socket 20, however, when a larger hex head or nut 120 is engaged, the inner socket 20 moves inward and out of the way to enable the outer socket 30 to engage the larger hex head or nut 120.

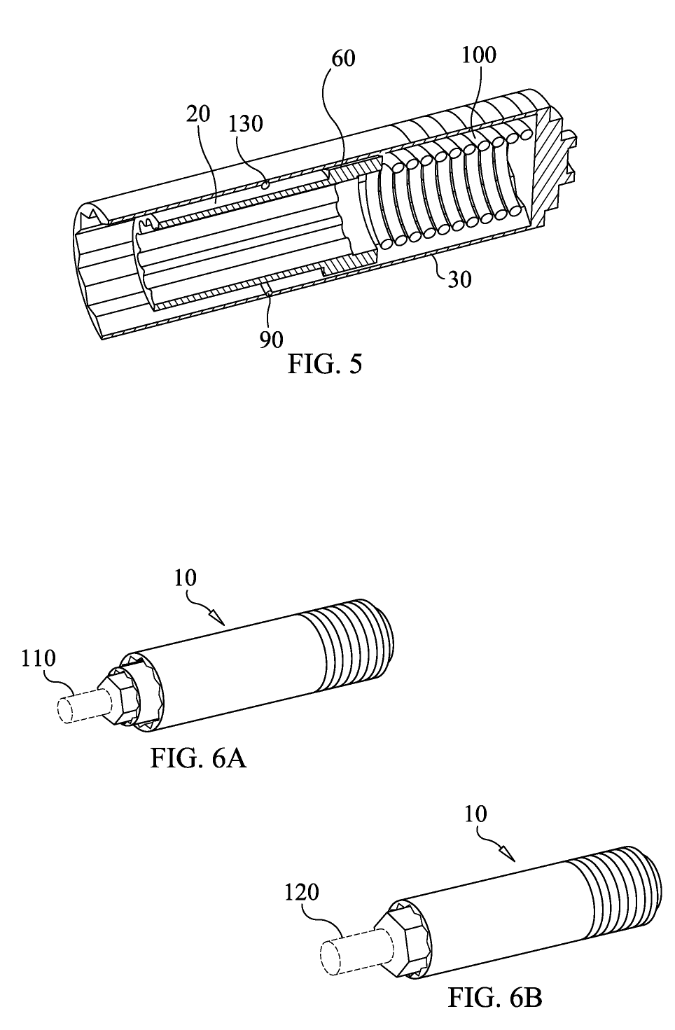

In various embodiments, the outer socket 30 includes an indentation, or indented groove, 130 in an inner surface adapted to receive the retaining clip 90. The retaining clip 90 protrudes from the inner surface sufficiently to prevent the base portion 60 of the inner socket 20 from moving longitudinally past the retaining clip 90. The retaining clip 90 is any suitable retaining clip. In certain embodiments, the retaining clip 90 is a circlip forming a portion of a circle. FIG. 5 shows a cut-away of the assembly 10 in a mode in which the inner socket 20 is compressing spring 100 and pressed into the outer socket 30. However, when spring 100 is fully pressing inner socket 20 outward, the edge of base 60 is locked against retaining clip 90 and prevented from moving further outward, and inner socket 20 protrudes even with or beyond outer socket 30.

In various embodiments, the external pattern 50 on the base portion 60 of the inner socket 20 is an external double hex pattern, and the second internal surface pattern 80 of the outer socket 30 is an internal double hex pattern adapted to engage the external double hex pattern 50. Ideally, the base portion 60 of the inner socket 20 has a longitudinal length sufficient to provide for a robust stable configuration. For example, ideally, the length of the base portion 60 is at least 0.25 inches.

In various embodiments, the inner socket 20 and outer socket 30 may be sized and configured as desired. In one embodiment, the inner socket 20 is sized and configured to engage a 9/16 inch size hex head or nut, and the outer socket 30 is sized and configured to engage a ¾ inch size hex head or nut. In various other embodiments, these sockets may be hex patterns, double hex patterns, or any suitable pattern for engaging other shapes and sizes of hardware.

It is understood that additional embodiments of the present invention may include iterations in which a third socket, fourth socket, or as many sockets as desired, may be nested within one another in like configuration to allow the assembly 10 to be used for more multiple sizes of hex heads or nuts.

Ideally, the outer socket 30 includes a configuration at a proximal end adapted to receive an adapter bit of an impact driver. Thus, the assembly 10 may be easily attached to a power driven impact driver 140.

While specific embodiments have been illustrated and described, numerous modifications come to mind without significantly departing from the spirit of the invention and the scope of protection is limited by the scope of the accompanying claims.

What is claimed is:

1. A nested socket assembly comprising:
an inner socket having a first internal surface pattern adapted to engage a first nut, and an external surface pattern along a base portion of said inner socket, wherein at least a portion of the external surface pattern along said base portion protrudes axially beyond a shaft surface adjacent said base portion,
an outer socket having a second internal surface pattern adapted to engage a second nut larger than such a first nut, the surface pattern of said outer socket also being adapted to engage the external surface pattern of said inner socket,
wherein said inner socket is nested within said outer socket, and wherein said inner socket is longitudinally movable with respect to said outer socket and said inner socket is prevented from moving longitudinally beyond a stopping point via a retaining clip.

2. The nested socket assembly according to claim 1, further comprising a compression spring disposed within said outer socket beyond a base of said inner socket adapted to apply force to push said inner socket toward a distal end of said outer socket.

3. The nested socket assembly according to claim 2, wherein said inner socket, said outer socket, said retaining clip, and said spring are positioned in a configuration wherein, under the condition that no pressure is applied to a distal end of said inner socket, the distal end of said inner socket is positioned even with or beyond a distal end of said outer socket, and wherein under the condition that force is applied to the distal end of said inner socket, said inner socket is free to move longitudinally to the extent that the distal end of said inner socket is positioned inward of the distal end of said outer socket.

4. The nested socket assembly according to claim 3, wherein said outer socket comprises an indented groove in an inner surface adapted to receive said retaining clip, and wherein said retaining clip protrudes from said inner surface sufficiently to prevent the base portion of said inner socket from moving longitudinally past said retaining clip.

5. The nested socket assembly according to claim 4, wherein said retaining clip comprises a circlip.

6. The nested socket assembly according to claim 4, wherein the external pattern on the base portion of said inner socket comprises an external double hex pattern, and wherein the second internal surface pattern of said outer socket comprises an internal double hex pattern adapted to engage said external double hex pattern.

7. The nested socket assembly according to claim 6, wherein said outer socket comprises a configuration at a proximal end adapted to receive an adapter bit of an impact driver.

8. The nested socket assembly according to claim 4, wherein said inner socket is configured to engage a hex head of size 9/16 inch, and wherein said outer socket is configured to engage a hex head of size .

9. The nested socket assembly according to claim 6, wherein said first internal surface pattern of said inner socket comprises an inner socket internal double hex pattern.

10. The nested socket assembly according to claim 9, wherein said inner socket is configured to engage a hex head of size 9/16 inch, and wherein said outer socket is configured to engage a hex head of size ¾ inch.

11. The nested socket assembly according to claim 7, further comprising a power driven impact driver operably engaged with said outer socket.

12. The nested socket assembly according to claim 6, wherein said base portion of said inner socket has a longitudinal length of at least 0.25 inches.
